(19) United States
(12) Patent Application Publication
(10) Pub. No.: US 2012/0281784 A1
(43) Pub. Date: Nov. 8, 2012

(54) CORRECTION OF ANALOG DEFECTS IN PARALLEL ANALOG-TO-DIGITAL CONVERTERS, IN PARTICULAR FOR MULTI-STANDARD, SOFTWARE-DEFINED RADIO, AND/OR COGNITIVE RADIO USE

(75) Inventors: Ali Beydoun, Mignaloux Beauvoir (FR); Van Tam Nguyen, Antony (FR); Patrick Loumeau, Marolles en Brie (FR)

(73) Assignee: GROUPE DES ECOLES DES TELECOMMUNICATIONS - ECOLE NATIONALE SUPERIEURE DES TELECOMMUNICATIONS, Paris Cedex 13 (FR)

(21) Appl. No.: 13/387,904

(22) PCT Filed: Jul. 28, 2010
(86) PCT No.: PCT/FR2010/051603

§ 371 Date: Feb. 27, 2012

(30) Foreign Application Priority Data
Jul. 30, 2009 (FR) 09 55351

(51) Int. Cl. H04L 1/00

(52) U.S. Cl. 375/295

(57) ABSTRACT

The present invention relates to signal processing in an analog-to-digital converter comprising a time-interleaved multi-channel architecture. According to the invention: digital filtering (H(z)) is applied in each channel, at least to estimate a converter offset error, and a compensation for the offset is applied on the basis of the estimated offset error. Advantageously, it is possible to benefit from the presence of a digital filter (H(z)) that is usually used to filter the quantization noise, such as a comb filter in converters that have sigma/delta modulators, in order to estimate the offset. The same filtering can then be applied in order to also estimate a gain disparity between the different channels.

The present invention concerns the processing of a signal issuing from an analog-to-digital conversion.

The current trend in telecommunication systems is the increasing integration of services and applications (multimedia, Internet, television, GPS, WiFi applications, etc.) that make use of a variety of reception standards. In addition to the proliferation of standards, the expansion of transmission bandwidths is leading to the need to design receivers which adapt to different standards while operating over a wide band. For multi-standard functionality, the possibility of reconfiguring receivers online using software is particularly beneficial, giving rise to the term “software-defined radio” for such devices. In addition, such receivers allow real-time analysis of the state of the frequency band, for intelligent spectrum management. This is referred to as “cognitive radio”.

To achieve such goals, the signals received must be digitized as close as possible to the antenna to allow the software processing and intelligent spectrum management. In this context, one promising solution is to have parallel analog-to-digital converters in a multi-channel structure using the time interleaving technique. For example, a system with four channels using innovative sigma-delta modulators with appropriate interpolation can provide an ideal signal-to-noise ratio (SNR) of 102 dB. Such sigma-delta modulators are described in particular in documents FR-08 58632 and FR-08 53213.

However, the inevitable presence of analog errors (presence of offset, gain differences in the various channels of the multi-channel structure) resulting from the manufacturing process considerably limits the performance expected from this type of converter. For example, with very small offsets (standard deviation of 2×10⁻⁶), the SNR ratio degrades by 30 dB. A drop of 30 dB in the SNR ratio due to gain differences is also observed with a standard deviation of only 0.1%.

Several solutions have been proposed for correcting these errors. These solutions can be classified into one of the three following approaches.

A first approach consists of eliminating the absolute error on each channel. This technique is based on estimating the offset and gain values for each modulator, in order to correct them by multiplying the output signal by the inverse of the estimated gain to correct the gain and by subtracting the estimated offset to correct the offset. Several methods have been proposed for achieving this.

The first method is described in the document:

“Calibration of parallel ΣΔ ADCs”, R. Batten, A. Eshraghi, T. Fiez, IEEE transactions on circuits and systems-II analog and digital signal processing, vol. 49, no. 6, June 2002, p. 390-399.

This method consists of using a digital sigma-delta modulator, upstream from the analog modulator, to estimate the errors and compensate for them. This method does not perform the correction in real time. The offset and gain estimation is done by the digital modulator, connecting the input of the analog modulator to the ground or to a constant reference voltage. The correction is done by adjusting the value in the return path of the digital modulator. The order of the digital modulator must be higher than that of the analog modulator to avoid increasing the noise level. This solution is not optimal in terms of resources used and power consumed, because it requires adding the same number of digital modulators as there are analog modulators, in addition to the digital processing.

The second method proposes real-time offset correction, as described in the document:

“Digital offset compensation of time-interleaved ADC using random chopper sampling”, J E Eklund, F Gustafsson, IEEE ISCAS 2000, Geneva, Switzerland, May 2000.

This method consists of multiplying the input signal of each modulator by a pseudo-random sequence {+1,−1} in order to whiten it. Then, at the exit from the modulator, calculating the mean value for N points provides an estimate of the offset value. Lastly, the estimated value is subtracted from the signal before multiplying the signal with the same pseudo-random sequence to obtain the useful signal. This second method has the following problems:
the multiplication by the pseudo-random sequence occurs in the analog domain, which is not very accurate; in addition, this analog multiplication adds constraints to the first stage of the sigma-delta modulator,
whitening the signal at the input to the modulator increases the level of noise and complicates the shaping of the quantization noise by the modulator when it is of lower order and the analog-to-digital converter (or ADC) in the loop has a low number of bits,
the multiplication by the same sequence at output does not allow recovering the useful signal if the gain of the signal transfer function (STF) of the modulator is not equal to one,
it is not possible to correct errors in the receiving chain introduced before the multiplication by the pseudo-random sequence at the input to the modulator.

A third method dedicated to correcting absolute gain error in high-pass sigma-delta modulators, non-real-time, has been proposed in the document:

“Advantages of high-pass ΔΣ modulators in interleaved ΔΣ analog to digital converter”, V. T. Nguyen; P. Loumeau; J. F. Naviner, Circuits and Systems, MWSCAS-2002 (45th Midwest Symposium), Volume 1, 4-7, Page(s): I-136-I-139, August 2002.

This method uses stochastic least square algorithms, which offer the advantage of simplicity in the implementation, for estimating the inverse of the gain on each channel. However, the disadvantage of this method is that it must be applied with no offset present; otherwise the error in estimating the inverse of the gain is too high. As a general rule, it is therefore preferable, in the case of low-pass modulators, to apply an offset correction before beginning the gain error correction. In addition, this method requires knowing the ideal response of the time-interleaved architecture to an input reference signal, which presents difficulties in the implementation because of the chaotic behavior of sigma-delta modulators.

A second approach is based on equalization of the errors on the different channels.

Given that the appearance of spectral line noise in the output is due to mismatch between the gain and offset errors of sigma-delta modulators, this second approach also aims to equalize these gain and offset errors.

In order to equalize the errors on all channels, document EP1401105 proposes a method which consists of using a supplemental analog-to-digital converter as a reference converter. This supplemental converter is then connected in parallel with the converter in the correction phase in order to equalize its offset and gain with those of the reference converter. Although this method offers the advantage of performing the correction in real time, the offset correction cannot be perfect because of the presence of gain errors that cannot be overcome. In addition, the digital processing to equalize the gain errors is fairly complex.

To avoid adding a supplemental converter to perform the gain correction in real time, it has been proposed to replace the supplemental analog-to-digital converter with a single-bit digital-to-analog converter, a pseudo-random signal {+1,−1} generator, and a digital unit in which is embedded the least mean square (LMS) algorithm for equalizing the gains, in the document:

“A digital background calibration technique for time-interleaved analog-to-digital converters”, D. Fu, K. C. Dyer, S. H. Lewis, P. J. Hurst, IEEE Journal of Solid-State Circuits, December 1998.

The disadvantage of this method is that the processing occurs at input into the modulator, therefore in the analog domain, and it does not allow eliminating the offset.

The third approach consists of whitening the gain and offset errors by spreading the energy of the spectral lines issuing from these errors across the entire frequency range. To do this, the following document proposes adding a supplemental modulator to the time-interleaved architecture with a technique of random channel selection, while ensuring the proper operation of the time-interleaved converter:

“A comparative analysis of parallel delta-sigma ADC architectures”, A. Eshraghi and T. Fiez, Circuits and Systems I: Regular Papers, IEEE Transactions on, vol. 51, no. 3, p. 450-458, 2004.

However, this technique entails additional calculation resources (also called the necessary “surface area”) in the converter, by requiring a supplemental modulator. In addition, it results in a decrease in the desired SNR ratio because of the increase in noise level following the whitening of the gain and offset errors.

None of the above techniques appear to be satisfactory for effectively correcting both the offset and the gain mismatches without demanding too many resources and without significantly degrading the SNR ratio.

The invention aims to improve the situation.

It proposes a method for processing a signal, in an analog-to-digital converter comprising a multi-channel time-interleaved architecture, wherein the following are applied:
digital filtering in each channel for at least estimating an offset error of the converter, and
compensation for the offset as a function of the estimated offset error.

The invention therefore proposes a precise estimation of defects such as the offset and possibly the gain difference, for the purpose of effectively correcting them. The major advantage of a precise estimation of the offset will be shown in the following detailed description. The invention allows significantly reducing all unwanted effects due to analog defects. For example, with very small offsets (a standard deviation of 2×10⁻⁶), the SNR ratio usually degrades by 30 dB and/or a drop of 30 dB in the SNR ratio is usually observed due to gain differences, with a standard deviation of only 0.1% in the gain values. The digital correction proposed by the invention allows maintaining the general SNR ratio of the system above 100 dB (which is a decrease of about 2 dB compared to an ideal processing with no attenuation of the SNR ratio).

In an advantageous embodiment, the invention makes use of a multi-channel architecture with a sigma-delta modulator in each channel and, in particular, digital filtering is applied in each channel in order to both:
reconstruct a useful signal issuing from the analog-to-digital conversion, and
estimate the offset error.

The estimation of the offset error is preferably achieved, as will be demonstrated below, by selective digital low-pass filtering. For example, a measurement shows that the bandwidth of the low-pass filter (−3 dB bandwidth) is equal to 0.0025*fₑ (where fₑ is the sampling frequency of the converter).

Advantageously, the filtering is applied to each channel by a comb filter. This takes advantage of the usual presence of such a filter in a converter having a time-interleaved architecture, to obtain a precise estimation of the offset in order to compensate for it.

The offset compensation itself preferably comprises the steps of:
applying a null signal as input to the converter in order to obtain the offset alone as output,
using the digital filtering to estimate an offset value for each channel, and
compensating for the estimated value of the offset on each channel.

In a preferred embodiment described in detail below, the offset error is estimated at a precision of less than 10^{-(0.3n+1.9)}, where n is the resolution, in number of bits, of the converter. It will be demonstrated below that in an exemplary embodiment, a compensation of an offset error estimated at this precision limits the loss in the signal-to-noise ratio to less than 3 dB.

In an advantageous embodiment, the invention additionally provides for equalizing the gains across the different channels of the converter. Advantageously, the abovementioned digital filtering is also applied to equalize the gain across the different channels of the multi-channel architecture, after compensation for the offset.

In one embodiment, the following steps are performed:
a same constant signal is applied to each channel,
an output signal is collected, corresponding to a product of this same signal and a gain specific to each channel,
the product from each channel is compared to the product from a reference channel in order to estimate, for each channel, a gain equalization weight relative to the reference channel.

Estimating the weight for a channel is preferably conducted by applying iterative processing that uses least mean squares, in a relation of the type

ŵᵢ[n+1]=ŵᵢ[n]+μfᵢ[n], where:
ŵᵢ[n+1] and ŵᵢ[n] are estimates of the weight for a channel i, respectively for the iterations n+1 and n,
μ is a constant,
fᵢ[n] is the product:
   of the difference between the output signals from the reference channel and channel i, and the sign of the output signal from channel
   or of the output signal from channel i and the sign of the difference between the output signals from the reference channel and channel i,
   or of the output signal from channel i and the difference between the output signals from the reference channel and channel i,
   or of the sign of the output signal from channel i and the sign of the difference between the output signals from the reference channel and channel i.

Of the processing described, an advantageous processing follows a relation of the type:

ŵᵢ[n+1]=ŵᵢ[n]+μ(y_{ref}[n]−yᵢ[n])×sgn(yᵢ[n]), where:
y_{ref}[n] and yᵢ[n] are the respective output signals from the reference channel and channel i, and
the notation sgn(x) indicates the sign of the real number x.

In an advantageous embodiment, the equalization weight is estimated at a precision of less than 10^{-(0.34n-0.65)}, where n is the resolution, in number of bits, of the converter. The above constant μ is preferably chosen to optimize a rate of convergence of the iterative processing and achieve this precision. In an exemplary embodiment described below, a value of 1 for the constant μ is found to be satisfactory.

The total number of iterations in the processing is chosen as a function of the constant μ. In the exemplary embodiment described above, an advantageous number is between 15 and 20 for a value μ=1.

In this exemplary embodiment, a gain equalization based on an estimation of the weight to the above precision, less than 10^{-(0.34n-0.65)}, limits the signal-to-noise ratio loss to less than 3 dB.

The weight values to be estimated are preferably encoded in a number of bits of between n+1 and n+4, where n is the resolution, in number of bits, of the converter, as will be seen in an exemplary embodiment described below with reference to FIGS. 30 to 33.

The invention thus offers the following advantages:
compensating for the offset value for each modulator in the digital domain, unlike other solutions which only aim to correct the effect of offset mismatches in the different modulators,
equalizing the gain errors of sigma-delta modulators relative to a modulator in the architecture, with no need for an additional modulator,
no need for a reference signal,
good precision with a very short convergence time for estimating and correcting defects.

In one embodiment, as will be seen below, the invention only requires an accumulator (for the addition) to be added to each channel in addition to the existing physical resources used for the digital reconstruction of the useful signal.

In fact, in an advantageous embodiment, the estimation of the offset values does not require any additional physical resource beyond those provided in most existing structures. As will be seen below, the invention uses the digital filters which are usually already present for the digital reconstruction of the useful signal.

Also, the gain equalization does not require either a reference signal or a supplemental modulator. In fact, a modulator in the architecture advantageously serves as the reference modulator for the other modulators.

The converter in the sense of the invention can advantageously be used in reconfigurable radio applications which can operate in multiple standards and multiple applications (in GSM, UMTS, WiMAx or other networks, or in GPS positioning technology) and cognitive radio applications (OFDMA wideband modulation, typically) which have different operating bandwidths. It can also be used in other data acquisition systems requiring an increase in the operating bandwidth of the converter.

In another object of the invention, the analog-to-digital converter comprises a multi-channel time-interleaved architecture, said converter comprising in particular:
a digital filter in each channel, for at least estimating an offset error of the converter, and
means of compensating for the offset as a function of the estimated offset error.

Advantageously, the converter additionally comprises a means for equalizing the gains of the different channels, and the digital filter is also made use of for estimating a gain equalization across the different channels of the multi-channel architecture, after compensation for the offset.

The invention also relates to a computer program comprising instructions for implementing the method of the invention when this program is executed by a processor, particularly a converter in the sense of the invention.

Other features and advantages of the invention will be apparent from the following detailed description, and the attached drawings in which:

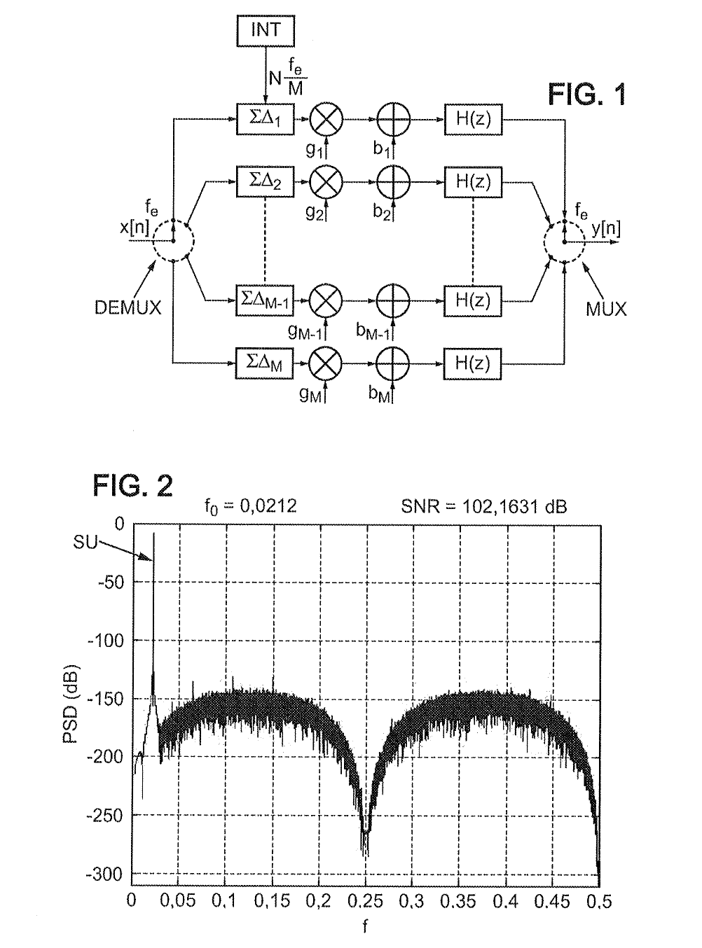

FIG. 1 illustrates an time-interleaved architecture having gain and offset errors in the modulators,

FIG. 2 represents an example of the spectral density of the output signal from the time-interleaved architecture in an ideal case, the scale on the x axis being the relative frequency (f=F/Fe) in relation to the sampling frequency Fe,

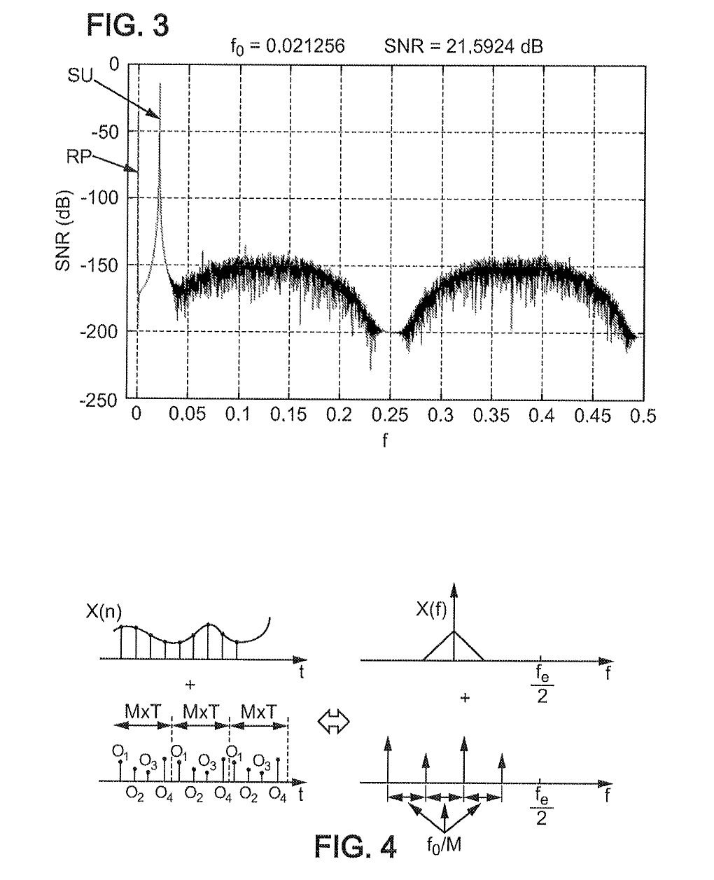

FIG. 3 represents the spectral density of the output signal from the time-interleaved architecture with an identical offset in all the modulators,

FIG. 4 illustrates the effect of mismatched offsets on the spectrum of the useful signal that is output (for four channels in the example represented),

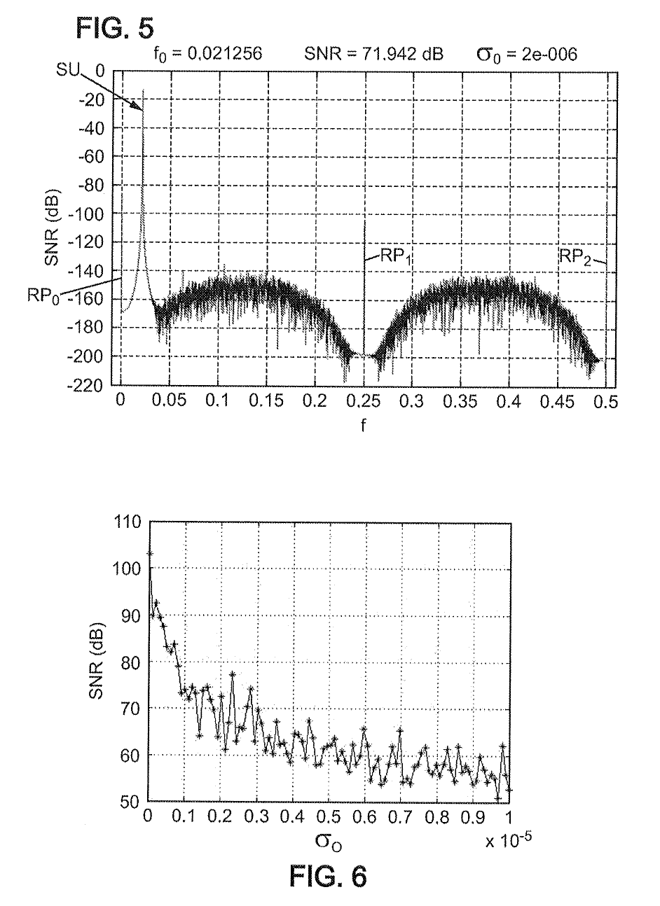

FIG. 5 illustrates the spectral density of the output signal with a different offset in all the modulators,

FIG. 6 illustrates the variation in the signal-to-noise ratio (SNR) as a function of the standard deviation of the offset values applied to the channels of the time-interleaved architecture,

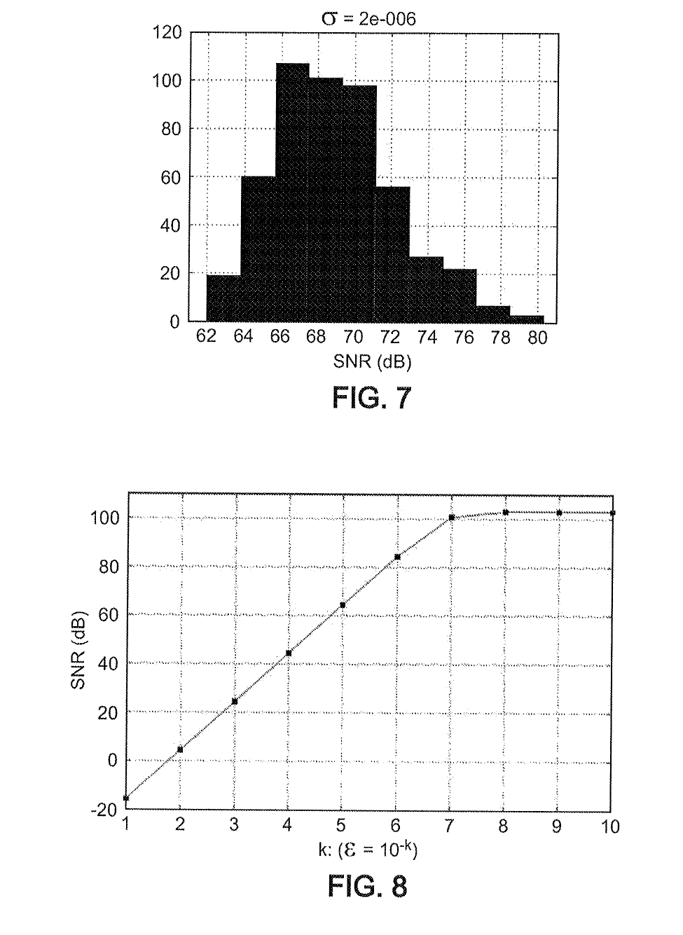

FIG. 7 shows a histogram of the signal to noise ratios (SNR) obtained with 500 iterations, with the standard deviation of the random offset being σ_{O}=2×10⁻⁶,

FIG. 8 shows the variation of the SNR ratio as a function of the precision of the estimated offset value for each channel,

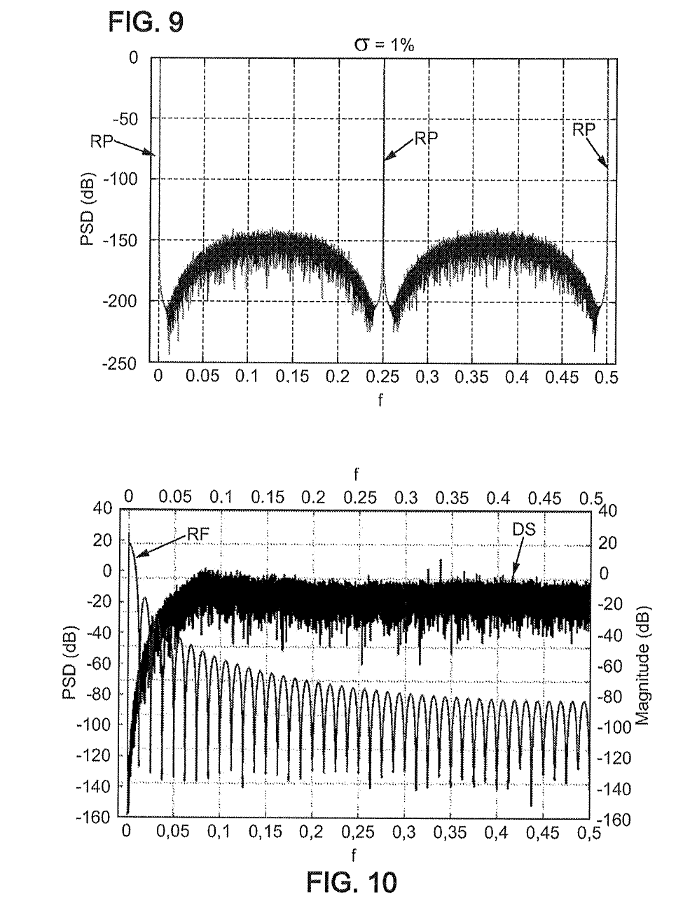

FIG. 9 represents the spectral density of the output signal from the converter with a Gaussian random offset and gain error on each channel,

FIG. 10 represents the spectral density of the output signal from a DS modulator and the frequency response RF of the comb filter,

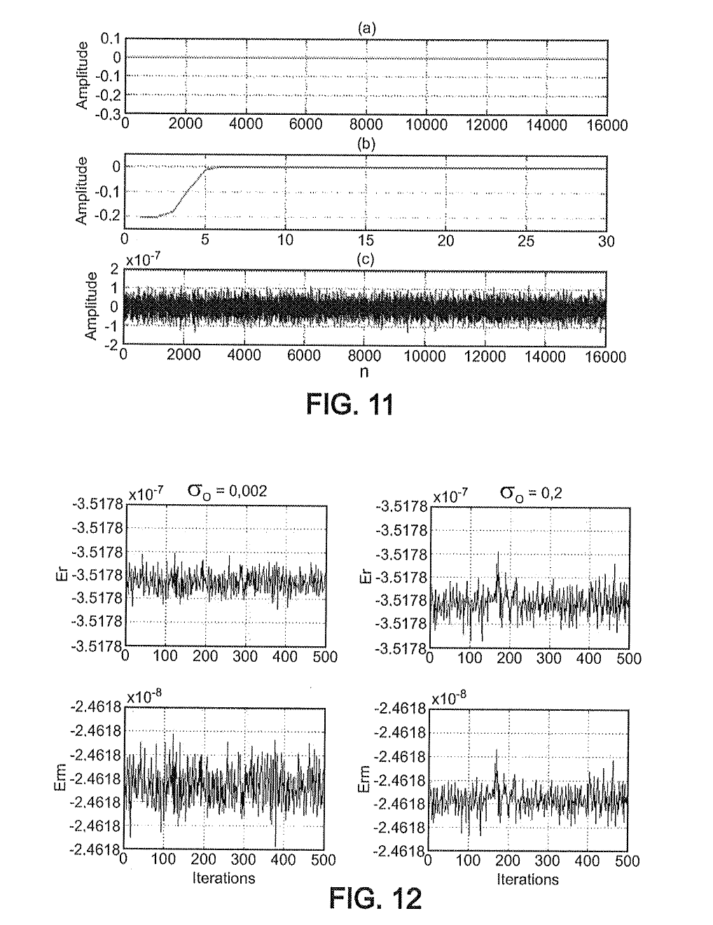

FIG. 11a shows the offset estimation error, while FIG. 11b shows the stabilization of the error after a few clock cycles (less than a dozen), and FIG. 11c shows the fluctuation in the error (around 10⁻⁷ even so) after stabilization,

FIG. 12 shows the estimation error Er and Erm with two standard deviation values σ_{O}=0.002 and σ_{O}=0.2, for different iterations,

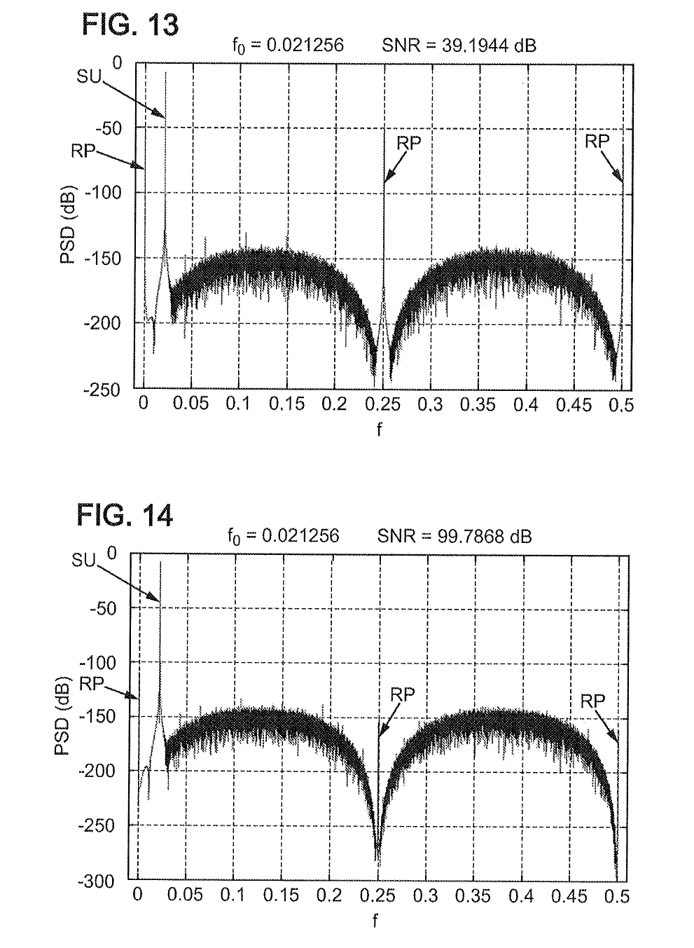

FIG. 13 shows the spectral density of the output signal with the offset errors not compensated,

FIG. 14 shows the spectral density of the output signal after correction of the offset errors, for the same example as in FIG. 13,

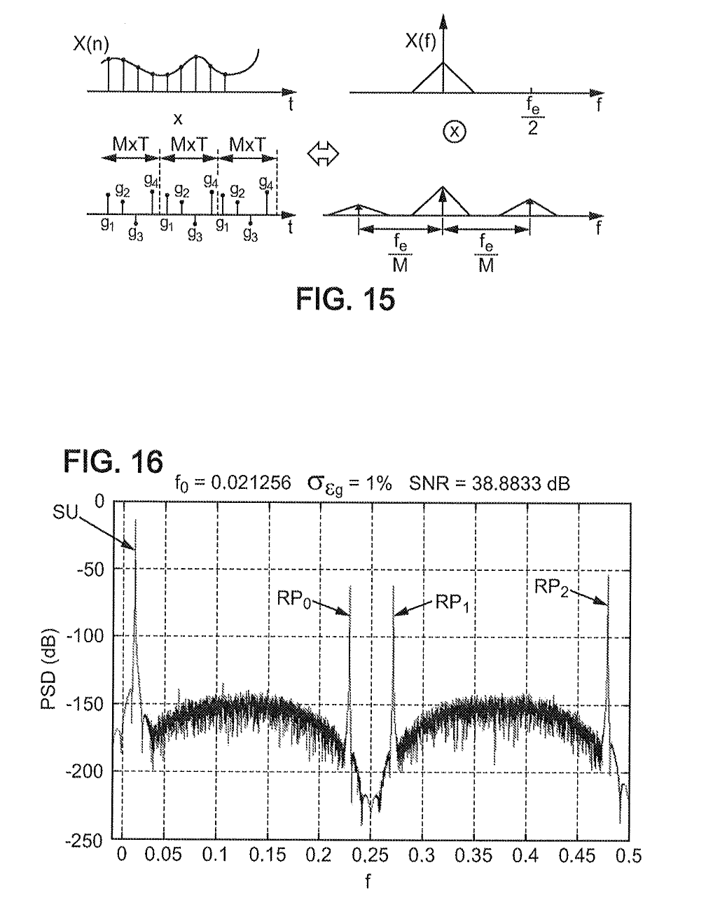

FIG. 15 shows the effect of mismatched gains on the spectrum of the useful signal that is output,

FIG. 16 shows the spectral density of the output signal with the gain differences in the channels,

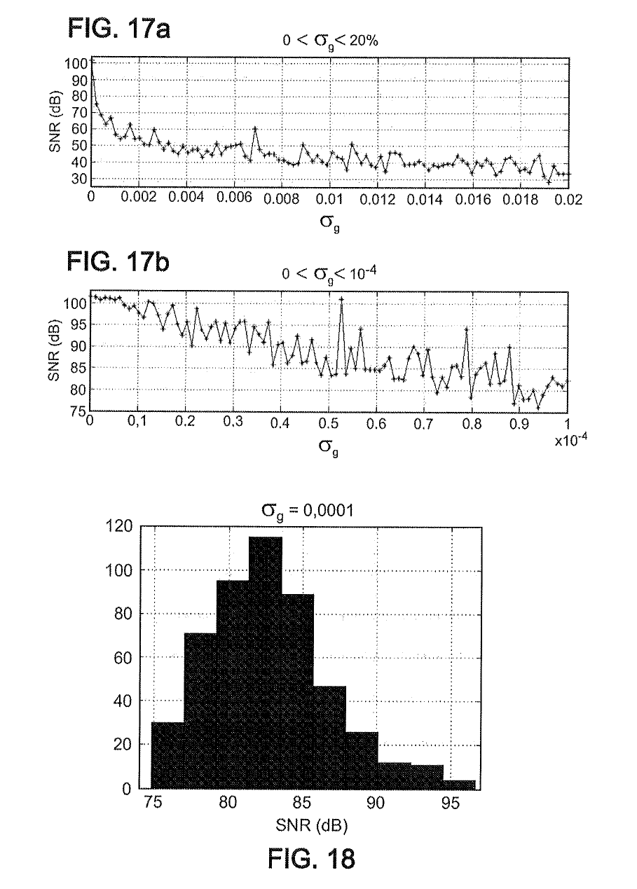

FIGS. 17a and 17b illustrate the variations (in general and in detail, respectively) in the SNR ratio as a function of the value of the standard deviation of the gain error,

FIG. 18 shows a histogram of the SNR ratios obtained with 500 iterations, with the standard deviation of the random gain being σ_{g}=10⁻⁴,

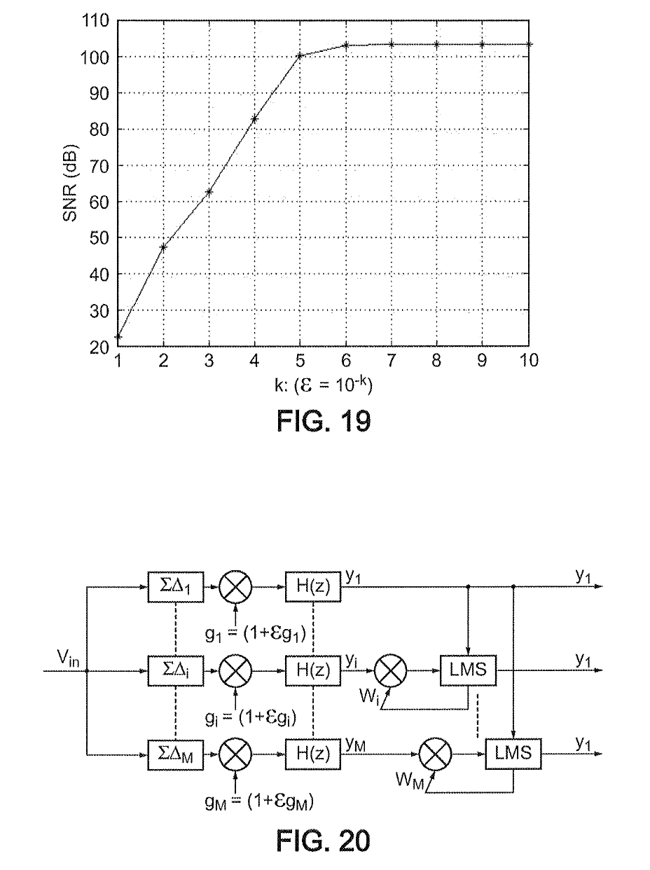

FIG. 19 shows the variation in the SNR ratio as a function of the precision of the estimated gain value for each channel,

FIG. 20 shows a block diagram of the gain equalization for the different channels in the time-interleaved architecture,

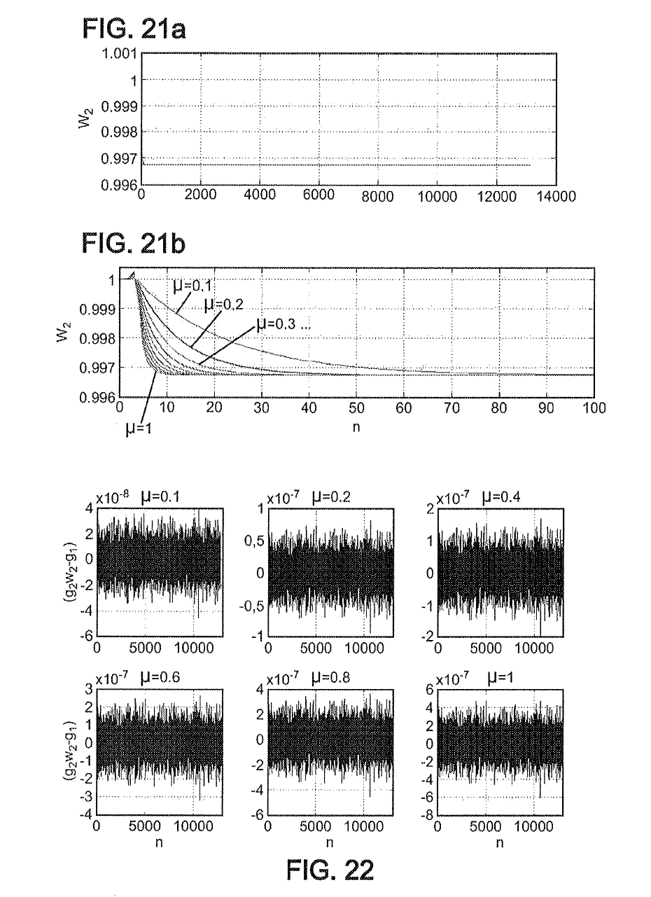

FIGS. 21a and 21b illustrate the weight estimation w₂ with different values for the convergence step-size μ, with the scale of the x axis restricted to 0≦n≦100 for FIG. 21b,

FIG. 22 shows the variation in the error in the weight estimation w₂ with different values for the convergence step-size μ,

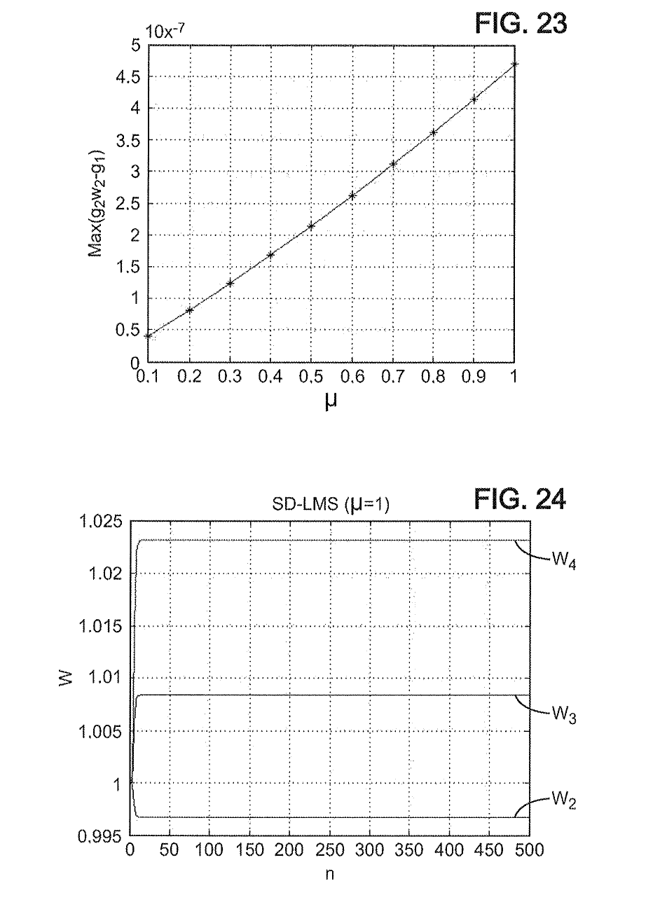

FIG. 23 shows the maximum error in the weight estimation w₂ as a function of the step-size μ,

FIG. 24 shows the convergence in the weight estimation w as a function of time for a step size such that μ=1,

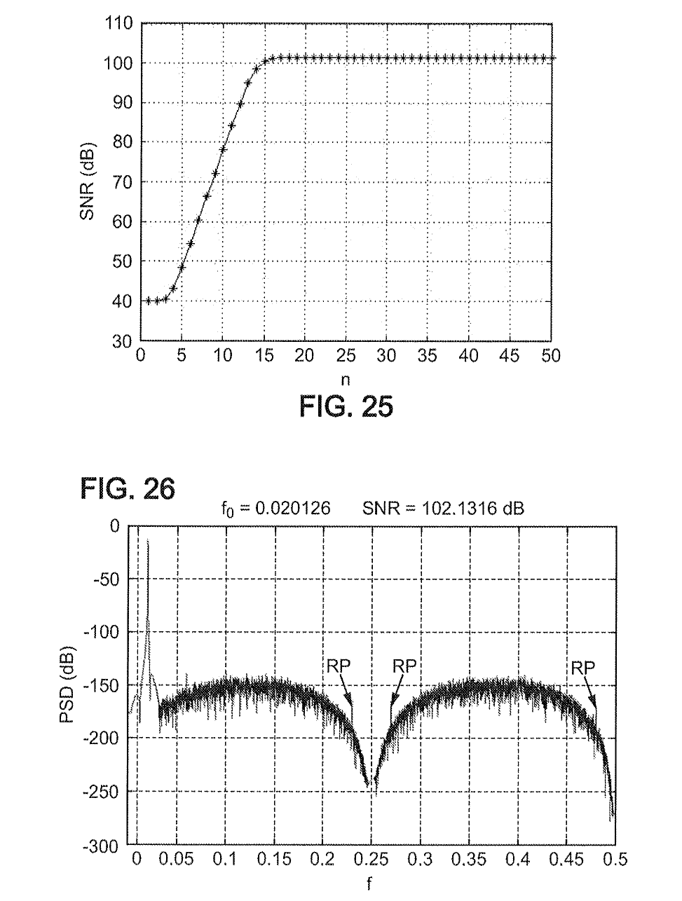

FIG. 25 illustrates the convergence of the SNR ratio as a function of the estimation time for the weight values w,

FIG. 26 illustrates the spectral density of the output signal after equalization of the gain errors,

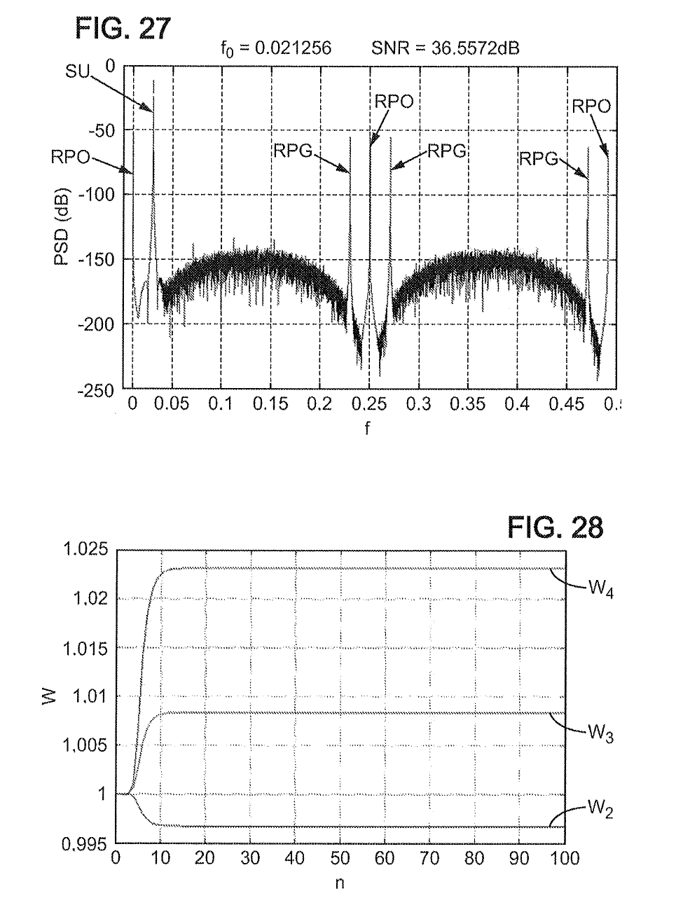

FIG. 27 illustrates the spectral density of the output signal which takes into account both gain and offset errors,

FIG. 28 shows the convergence of the weights w over time for a convergence step-size μ=1,

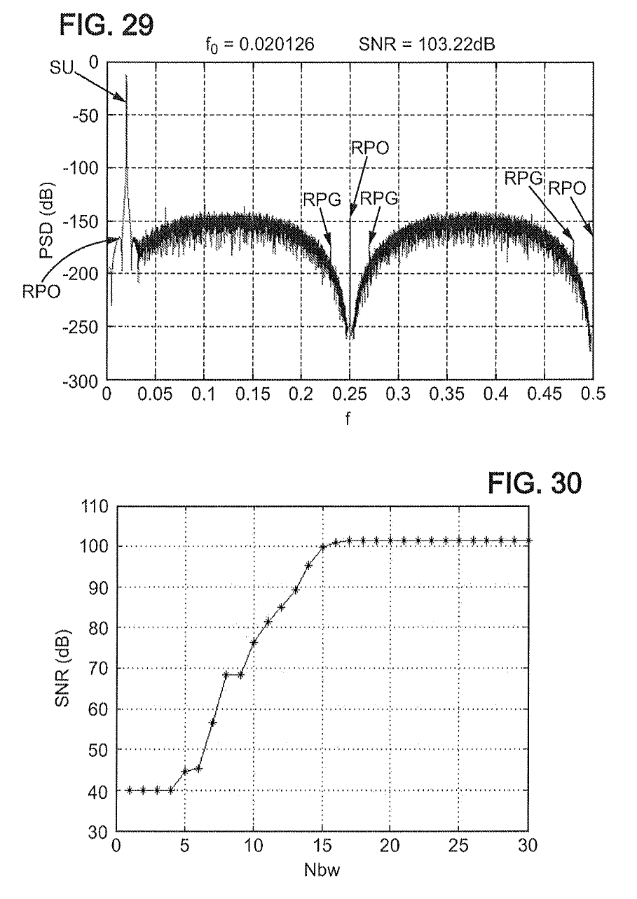

FIG. 29 illustrates the spectral density of the output signal after correction of the gain and offset errors,

FIG. 30 shows the evolution in the SNR ratio as a function of the number of bits quantizing the weight values w,

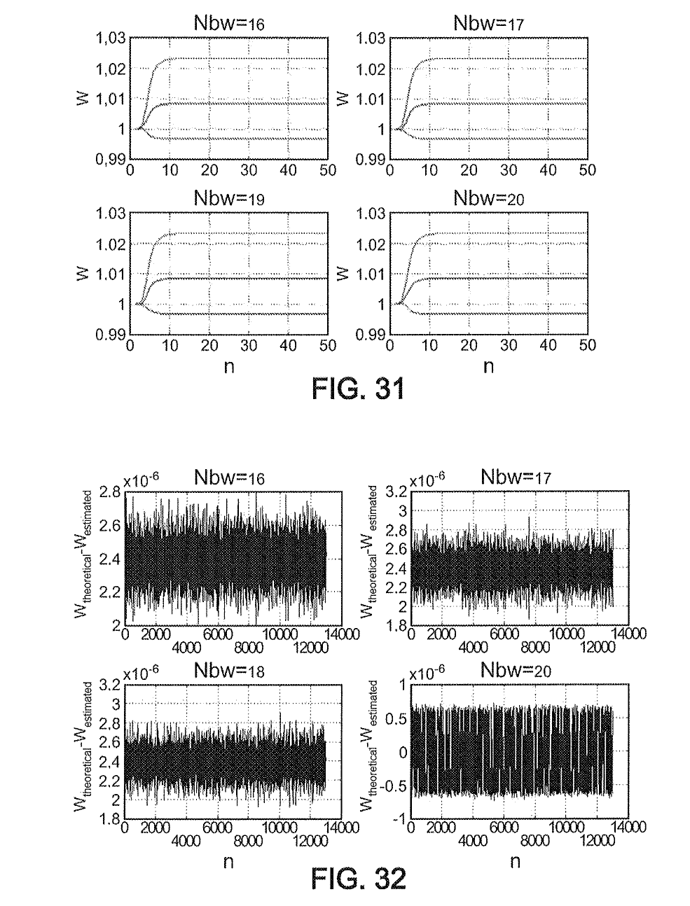

FIG. 31 shows the convergence of the weights w over time with μ=1 for different values of the number Nbw,

FIG. 32 shows the estimation error for the weight values w, for different values of the number Nbw,

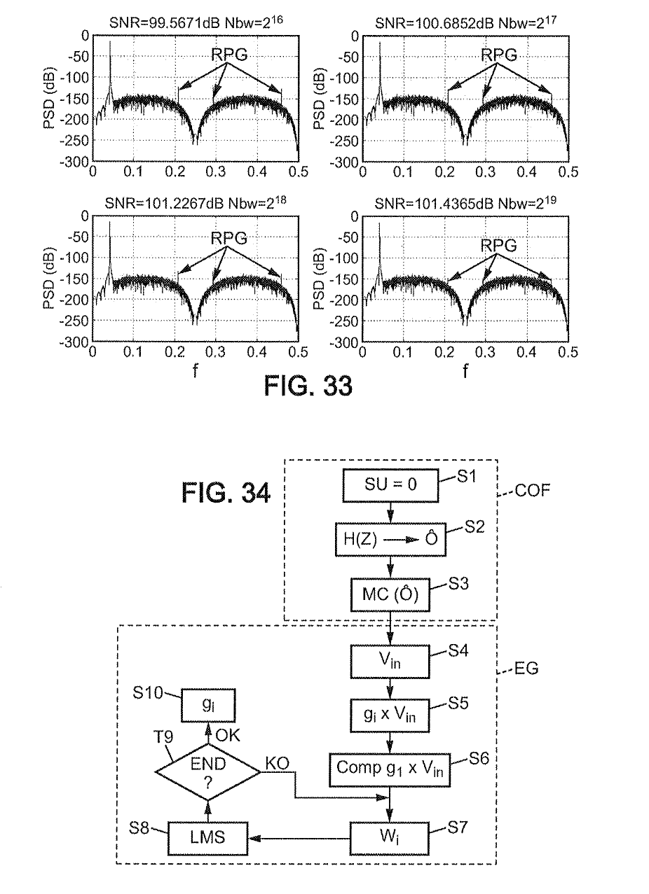

FIG. 33 shows the spectral density that is output when the gain is equalized by the weight w for different values of the number Nbw,

FIG. 34 illustrates the main steps of a method according to one embodiment of the invention,

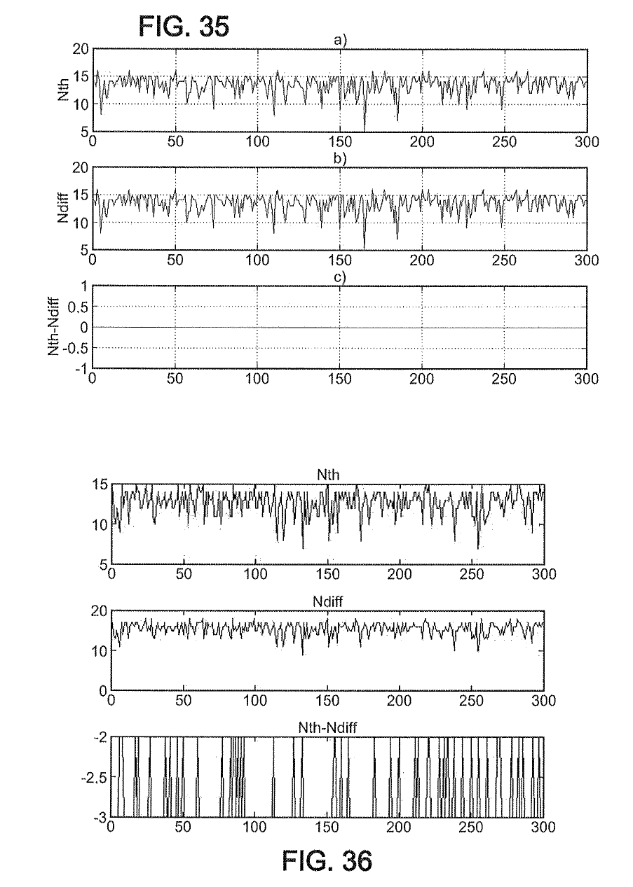

FIG. 35 illustrates the number of iterations Nth and Ndiff for a convergence using SD-LMS iterative processing for the weight estimation, respectively with a theoretical calculation and a calculation of the difference of two successive estimations,

FIG. 36 illustrates the rate of convergence obtained with a filter for which the transfer function is of the type (1−z^{Lf}) where Lf=3.

First we will refer to FIG. 1, representing the time-interleaved architecture of an analog-to-digital converter in which:
an analog demultiplexer DEMUR distributes the input signal to the M identical parallel sigma-delta modulators (denoted ΣΔ₁, . . . , ΣΔ_{M}),
an interpolator INT of order N inserts N−1 zeros between two successive samples of the signal,
a sigma-delta modulator ΣΔᵢ in each channel i shapes the quantization noise,
a digital filter H(z) eliminates the quantization noise outside the useful band, and
a digital multiplexer MUX reconstructs the digitized output signal.

Such an architecture has four important parameters:
the architecture of the sigma-delta modulator used and its order (P),
the number of parallel channels (M),
the interpolation rate (N),
the operating frequency of the modulators (fₒₚ which is defined as equal to (N/M)·fₑ where fₑ is the sampling frequency of the converter).

Various analog errors (errors in the rated values of the components, finite gain of amplifiers, or other errors), introduced during the manufacturing process of such a structure, are reflected in the sigma-delta modulator as voltage offset and gain error in the signal that is output from each channel in a time-interleaved architecture.

Such errors considerably limit the performance of parallel time-interleaved architectures. In fact, the mismatch between offset values is evident, in the spectrum of the useful signal that is output, as spectral lines at normalized frequencies k/M where k is an integer. In addition, voltage offset, whether in a single modulator or in a parallel architecture, can obscure the useful information present at the null frequency. This voltage offset causes a considerable drop in the signal-to-noise ratio (SNR) of the converter even if it is identical for all the modulators.

In addition, gain mismatch creates replicas of the useful signal every k/M frequencies in the spectrum of the output signal. These undesirable replicas of the useful signal cause a drop in the SNR ratio at the output from the converter.

It is therefore proposed to estimate these errors precisely and correct them in order to maintain the desired performance of the parallel time-interleaved architecture. For this purpose, steps are conducted to:
compensate for the value of the offset at the output from each modulator, and
equalize the gains of the different channels.

As a purely illustrative example that is not intended to be limiting, a case is described below of a parallel architecture having four channels (M=4), with a rate of interpolation of 80 (N=80) at the input to the modulators. The order of the sigma-delta modulators used is equal to 4 (P=4). The digital filter H(z) used is a sixth-order comb filter. The input signal is a sinusoid signal with a normalized amplitude of 0.6 and normalized frequency f₀=0.02 (therefore of absolute frequency 0.02fₑ). The spectral density of the useful signal SU at output, in the absence of errors, is presented in FIG. 2. The signal-to-noise ratio (SNR) estimated in this ideal case is equal to 102 dB.

The influence of offset errors is described below.

The offset that sigma-delta modulators introduce in each channel causes a strong drop in the SNR ratio and limits the performance of the time-interleaved analog-to-digital converter. To illustrate this effect, the following two cases are distinguished:
the case of an identical offset for all modulators, and
the case of different offsets for various modulators.

In the first case, the normalized value of the introduced offset relative to the reference voltage is equal to 4.11×10⁻⁴, in one simulation example. FIG. 3 shows the spectral density of the output signal obtained with this type of error. A parasitic spectral line RP appears at the null frequency of the same amplitude as the useful signal, introducing a drop in the SNR ratio of 80 dB.

Having an identical offset in all the channels does not introduce any distortion in the useful signal. However, the useful information at the null frequency is erroneous, which introduces a major source of error in the digital processing which follows the converter (in terms of thresholding, modulation, etc.).

Although this first case is not very realistic, its simulation is presented here to show to that offset compensation is already useful, even if the offset is identical for all modulators.

The second case in which the offset differs for the various modulators is more realistic. The mismatch between the offsets of the different modulators is reflected as spectral lines in the spectrum of the useful signal that is output. This phenomenon is evident in FIG. 4 in the time (on the left) and frequency (on the right) domains. The cyclic multiplexing at the output from the time-interleaved architecture adds, to the useful signal, a periodic signal formed by the different offsets Oᵢ. This signal is periodic with period M (here M=4), which introduces spectral lines into the frequency domain at the frequencies

$$\frac{{kf}_{e}}{M} {\vert}_{k = 0 … M - 1}$$

(therefore, in the example described, four lines spaced apart by fₑ/4 as represented).

FIG. 5 shows the spectral density of the output signal considering different offsets that are normalized relative to the reference voltage, generated by a random signal of Gaussian distribution with zero mean and a standard deviation σ_{O}=2×10⁻⁶ (N(0, σ_{O})). Only the first three parasitic lines are represented here: RP₀ (at the null frequency), RP₁ (at the frequency fₑ/4) and RP₂ (at the frequency fₑ/2), a fourth line being found at the frequency 3fₑ/4. In particular, a variable amplitude of the lines is observed which is a function of the standard deviation σ_{O}.

With a standard deviation of this value of 2.10⁻⁶, one can already see in FIG. 5 a significant drop in the SNR ratio, on the order of 30 dB. To determine the order of magnitude of the mismatch between the offsets which allows maintaining the desired SNR ratio, the SNR ratio has been calculated as a function of the standard deviation σ_{O} of the offset added to each channel. The result obtained is illustrated in FIG. 6. The curve obtained shows that the architecture is very sensitive to offset errors. An error on the order of 10⁻⁵ can cause a drop in the SNR ratio of 50 dB.

To determine the range of variation of the SNR ratio, Monte-Carlo simulations running for 500 iterations were conducted while considering random offsets of Gaussian distribution N(0, σ_{O}), with a standard deviation σ_{O}=2×10⁻⁶. For purely illustrative purposes, FIG. 7 shows the histogram of the values obtained for the SNR ratio. Note an average drop in the SNR ratio of 30 dB with a standard deviation of 4 dB.

Based on these results, one can see that a slight matching error between the offsets can result in a loss of 30 dB from the desired SNR ratio. It is therefore preferable to compensate for the offset on each channel, as precisely as possible for the desired SNR ratio. For this purpose, the value of the offset must be precisely determined, then subtracted from the signal output from each modulator.

Before proceeding to the estimation phase, it is first preferable to determine the precision desired for the estimated value. To do this, the SNR ratio is calculated by introducing a relative error into the estimated value of the offset defined by:

estimated_value=theoretical_value(1+ε)

where ε is the relative error between the estimated value and the theoretical value of the offset.

FIG. 8 shows how the SNR ratio evolves as a function of the relative error ε. A plateau appears starting at a precision on the order of 10⁻⁷. Such a precision is then preferable for ensuring offset compensation and for maintaining the theoretical SNR ratio expected from the time-interleaved architecture.

In fact, note the evolution in the SNR ratio in FIG. 8, which is substantially linear as a function of the precision, before reaching saturation when the amplitude of the parasitic lines generated by the offset mismatch decreases to the level of the quantization noise.

From this, one can see that in the linear part, a relation between the SNR ratio and the precision can be determined of the type SNR=20×k−36, such that the precision in the offset estimation is written:

$$precision = {10}^{- k} = {10}^{- ( \frac{SNR + 36}{20} )}$$

Given that the SNR ratio, as a function of the number n of equivalent bits of the converter (converter resolution), is given by SNR=6.02n+1.76, the precision in the estimated values for the offset is expressed by:

precision=10^{-k}=10^{-(0.3n+1.9)}

In the exemplary embodiments described below, the resolution n of the converter is, for example, equal to 16 (n=16).

The correction proposed by the present invention can be described as follows.

The signal output from the sigma-delta modulator, taking into account gain and offset errors, is expressed as:

y[n]=(x(n−M)+(z⁻¹NTF(z))*e[n])×g+O

where:
e[n] is the quantization noise that is inevitably generated by the analog-to-digital converter,
NTF(z) is a noise transfer function,
O indicates the offset,
g indicates the gain.

If the modulator input is connected to the ground, the output signal is expressed as:

y[n]=((z⁻¹NTF(z))*e[n])×g+O

Thus, in the absence of a useful signal, the problem no longer occurs of spectral lines in the output spectrum caused by gain mismatches between the different modulators. FIG. 9 shows the spectral density at the output, considering random gain and offset errors, of Gaussian distribution N(0.1%). The lines RP due to offset mismatches then appear independently of the useful signal.

The signal output from the modulator consists of the offset plus quantization noise assumed to be white noise and shaped by the modulator. The estimation of the offset value based on the signal that is output from the modulator can therefore be done by a known estimator, Least Squares, which is expressed as:

$$\hat{O} = \frac{1}{Nech} {\sum }_{i = 0}^{Nech - 1} y ( i )$$

The notation Ô therefore indicates the estimation of the offset, based on a number Nech of values for the output signal y(i). The implementation of this estimator only requires an accumulator for adding the Nech data and a shift operation to divide by the number Nech if this number is a power of 2. The variance of the estimated value is given by:

$${σ}_{\hat{O}}^{2} = \frac{{σ}_{y}^{2}}{Nech}$$

As the noise power present in the signal is fairly large, the number Nech must be high to achieve a precision of 10⁻⁷ in the estimated value. It has been verified by simulation in 2¹⁸ samples that the maximum precision achieved is 5×10⁻⁶.

To improve the precision in the estimated value of the offset, a particularly advantageous embodiment makes use of the comb filter present in each channel (usually dedicated to the digital reconstruction of the useful signal), to decrease the noise power present in the signal. FIG. 10 shows the spectral density DS of the signal output from the modulator and the frequency response RF of the comb filter. Note that the comb filter allows obtaining the value of the offset found at the null frequency and ensuring strong attenuation of the noise (particularly quantization noise) present in the signal and found in the highest frequencies.

To determine the precision of the estimated offset value, the error between the output from the comb filter and the theoretical value of the offset has been calculated. The result obtained is illustrated in FIGS. 11a to 11c. A precision of 10⁻⁷ is advantageously achieved (FIG. 11c) after 10 simple operations at most (specifically 6 operations in the example represented), therefore corresponding to only 10 clock cycles of a processor (FIG. 11b illustrates the first clock cycles with 0≦n≦30). The precision achieved here is sufficient to ensure good offset correction. To further improve the precision, it is also possible to use a conventional least-squares estimator of a constant value buried in the noise at the output from the comb filter.

In order to validate the precision obtained with other offset values, other simulations have been conducted while varying the value of the standard deviation σ_{O} within the interval [0 . . . 20%]. For each value of the standard deviation σ_{O}, Monte-Carlo simulations were conducted using 500 iterations. For each iteration, the following were calculated:
the maximum error Er between the theoretical offset and the output from the comb filter on all channels of the time-interleaved architecture, such that:

Er=max((offsetᵢ−Filter_Outputᵢ)|_{i=1 . . . M})
the maximum error Erm between the theoretical offset and the offset that is estimated using the least squares estimator applied to the output from the comb filter on all channels of the time-interleaved architecture, such that:

$$Erm = max [ ( {Offset}_{i} - \frac{1}{Nech} {\sum }_{k = 1}^{Nech} {Filter\_Output}_{i} ( k ) ) {\vert}_{i = 1 … M} ]$$

FIG. 12 shows an example of the values of the errors Er and Erm obtained with the standard deviations σ_{O}=0.002 (to the left in the figure) and σ_{O}=0.02 (to the right in the figure), as a function of the number of iterations implemented.

This figure shows that:
the least squares estimator slightly improves the precision: with Nech=100, the precision, previously of order 10⁻⁷, becomes of order 10⁻⁸, such that the improvement in the precision ultimately only slightly decreases the amplitude of the parasitic spectral lines; in particular, beyond a precision of 10⁻⁸, a large improvement in the SNR ratio cannot really be expected (as illustrated above with reference to FIG. 8),
the estimation error does not in actuality depend on the value of the offset, but on the frequency response RF of the comb filter.

These results show that estimating the offset with a comb filter is sufficient to ensure good offset correction. In order to illustrate the effectiveness of this estimation, the following offset values [−0.202; 0.717; 0.765; 0.1832]×10⁻⁴ were added to the different channels of the time-interleaved architecture in a simulation.

FIGS. 13 and 14 show the spectral density of the output signal, respectively before and after the offset correction on each channel. As represented in FIG. 14, the offset compensation allowed achieving a strong decrease in the amplitude of the parasitic spectral lines RP, almost to the level of the quantization noise. The SNR ratio is thus improved by 60 dB using the correction in the sense of the invention. There is only a slight attenuation of 2 dB of the SNR ratio obtained after the correction, compared to the ideal SNR ratio.

Thus the offset compensation technique in the sense of the invention offers the following advantages over prior art methods:
it ensures good precision, in spite of the presence of the gain errors which are inevitable in a sigma-delta modulator,
it does not require any additional physical resource aside from those already dedicated to the digital reconstruction (particularly a comb filter),
it is fast and provides a convergence to a good estimate in less than 10 cycles of the processor clock.

Now we will describe the correction of gain differences between different channels. First the effects of such a difference will be presented, or in other words the influence of gain errors on a time-interleaved structure.

The multiplication by a gain gᵢ at the output from each modulator on each channel i of the time-interleaved architecture is equivalent to the multiplication of the useful signal by a periodic signal of period M formed by different gains gᵢ, as illustrated in FIG. 15 (on the left in the time domain, and on the right in the frequency domain). This multiplication by a periodic signal in the time domain is expressed, in the frequency domain, by a convolution between the spectrum of the useful signal and the spectrum of the periodic signal consisting of Dirac peaks at the frequencies

$$\frac{k}{{f}_{e}}$$

(where k is an integer), with the amplitudes dependent on all the gains gᵢ introduced in the different channels. This convolution implies the appearance, in the spectrum of the output signal, of replicas of the spectrum of the useful signal at frequencies

$$\frac{{kf}_{e}}{M} {\vert}_{k = 0 … M}$$

weighted by the gain of the spectral lines of the periodic signal.

FIG. 16 shows the spectral density of the useful signal SU at the output, with a gain gᵢ introduced in each channel (equal to (1+εg), where εg is a Gaussian random variable with zero mean and standard deviation σ_{g}=1%) which is applied to parasitic replicas RP₀, RP₁, RP₂ of the useful signal, due to the differences in the gains. With an error of 1% in the ideal gain for each channel, a drop in the SNR ratio of 60 dB can be noted. It is therefore proposed to correct these errors in order to maintain the expected performance of the time-interleaved architecture.

In order to determine the maximum relative error between the channels so as to avoid too much of a decrease in the SNR ratio, the SNR ratio was calculated as a function of the standard deviation of the gain error added to each channel. The obtained result is illustrated in FIGS. 17a (with a rapid variation in the standard deviation) and 17b (with a slower variation in the standard deviation). Note in FIG. 17b that the SNR ratio is maintained for a random error for which the value of the standard deviation σ_{g} is less than 10⁻⁵, which explains the high sensitivity of the time-interleaved architecture to gain mismatch errors. A greater standard deviation error, for example σ_{g}=10⁻⁴, already causes a drop of 30 dB in the SNR ratio. To determine the range of variation of the SNR ratio, 500-iteration Monte Carlo simulations were conducted. FIG. 18 shows the histogram of the values obtained for the SNR ratio. Note the average drop in the SNR ratio of 30 dB (to 82 dB), with a standard deviation of 4 dB.

The correction of these gain errors preferably occurs by multiplying the output signal from each channel by a weight w, equal to the inverse of the gain

$${w}_{i} = \frac{1}{{g}_{i}} .$$

Before proceeding with the correction of these errors, it is preferable to determine the precision required for the weight wᵢ. For this purpose, the SNR ratio was calculated by introducing a relative error to the estimated value defined by:

estimated_value=theoretical_value×(1+ε),

where ε is the relative error between the estimated value and the theoretical value of the weight wᵢ.

FIG. 19 shows the evolution in the SNR ratio as a function of the relative error ε. It shows that a precision on the order of 10⁻⁶ is preferable to ensure good correction of gain errors and to be able to maintain the almost ideal SNR ratio expected in a time-interleaved architecture. Here again, the precision in the weight values is obtained as a function of the general resolution n of the converter, as follows:

SNR=17.38×k+13.23

The precision in the gain estimation must therefore be equal to:

$$precision = {10}^{- k} = {10}^{- ( \frac{SNR - 13.23}{17.38} )}$$

As the SNR ratio is dependent on the number n of equivalent bits (resolution) of the converter, the SNR ratio is given by SNR=6.02n+1.76, and the precision for the estimated gain values is expressed as:

precision=10^{-k}=10^{-(0.35n-0.66)}

To correct the effects of the difference between the gains of the different modulators, a new technique is proposed based on the principle of gain equalization across the different channels. It is preferable, however, to apply a compensation of the offset errors beforehand. This technique presents the following advantages over other prior art techniques:
it does not require any reference signal,
it does not require any supplemental modulator,
it uses only an accumulator and a multiplier in addition to the digital processing which already exists for reconstructing the useful signal.

With reference to FIG. 20, the following steps are preferably carried out:
a continuous input signal Vᵢₙ is applied to all modulators at the same time: the amplitude of this constant signal is fixed in the described example at a value

$$\frac{{V}_{ref}}{2}$$

where V_{ref} indicates the voltage reference for the circuit (other values may be chosen subject to the condition that the chosen amplitudes do not make the modulator unstable),
the output signal from the modulator is formed from the constant signal that is input multiplied by the gain of the modulator gᵢ plus the shaped quantization noise (the modulator offset does not enter into it because it is assumed to have already been corrected),
the comb filter H(z) allows recovering the signal Vᵢₙ×gᵢ at the output from each channel,
processing that uses the least mean squares algorithm (or stochastic gradient), denoted LMS, is applied to calculate the different values of the weights wᵢ to be used to equalize the gain for all channels relative to a reference channel.

In the example in FIG. 20, the first channel is chosen as the reference channel, such that:

gᵢ×wᵢ=g₁|_{i=2 . . . M}

The LMS algorithm and its variants, such as those abbreviated as:
SD-LMS for Sign Data LMS,
SE-LMS for Sign Error LMS,
SS-LMS for Sign data Sign error LMS,
   offer great simplicity in implementation compared to other types of estimation algorithms.

The estimation of the weight value w, by these algorithms is governed by the following recurrence relations:

ŵᵢ[n+1]=ŵᵢ[n]+μ(y₁[n]−yᵢ[n])×yᵢ[n] LMS:

ŵᵢ[n+1]=ŵᵢ[n]+μ(y₁[n]−yᵢ[n])×sgn[yᵢ[n]] SD-LMS:

ŵᵢ[n+1]=ŵᵢ[n]+μsgn[y₁[n]−yᵢ[n])]×yᵢ[n] SE-LMS:

ŵᵢ[n+1]=ŵᵢ[n]+μsgn[(y₁[n]−yᵢ[n])]×sgn[yᵢ[n]] SS-LMS:

These four types of algorithms have been tested and compared concerning the convergence time and the precision of the estimated values. In the following, only the results obtained with the SD-LMS algorithm are presented to explain the operating principles and evaluate the performance of that implementation of the invention. The performance obtained with the other techniques is presented in a summary table below (Table I).

To illustrate the operating principle of this implementation, the gains [1.0113; 1.0146; 1.0029; 0.9884] have been introduced into the respective channels.

One of the parameters which determines the rate of convergence and the precision of the algorithm is the step-size of the algorithm μ. To determine the optimum value of the step-size μ, the weight w₂ of the second channel is estimated with different values for the step-size μ. The obtained result is illustrated in FIGS. 21a and 21b.

It appears that the greater the increase in the value of the step-size μ, the higher the rate of convergence of the estimation. However, it is also advisable to consider the behavior of the precision of the estimated value as a function of the step-size μ. For each value of the step-size μ, the error between the estimated value and the theoretical value (w₂g₂−g₁) has been calculated after the convergence was reached. The obtained results are illustrated in FIG. 22, for different values of the step-size μ.

FIG. 23 shows the maximum value obtained for the error as a function of the step-size μ. The greater the increase in the value of the step-size μ, the greater the increase in the error for the estimated value of the weight w₂. An optimum choice of convergence step-size μ, in the example described here, is μ=1. This choice also simplifies the algorithm by eliminating the multiplication operation (otherwise by a factor other than one), while ensuring good precision on the order of 5×10⁻⁷ for the estimation, as is shown in FIG. 23.

FIG. 24 shows the evolution in the estimation of the weight values for the different channels (w₂, w₃, w₄, the channel of index i=1 being the reference channel) as a function of the number of calculation operations (therefore as a function of the processor computing time) using the SD-LMS algorithm with a step-size μ=1. The convergence is rapid (at the end of n=20 processor clock cycles). The result of multiplying the weight values for each channel by the corresponding gain value is indeed equal to the gain value for the first channel used as the reference channel: 1.0113.

As a variant, it is possible to estimate the rate of convergence by calculating the SNR ratio that is output with each estimation of the weight vector [w₂, w₃, w₄] as a function of time. The obtained result is illustrated in FIG. 25. A good estimation of the weight vector which allows finding the desired SNR ratio is achieved after n=20 clock cycles (n=16 already being satisfactory).

FIG. 26 shows the spectral density of the output signal after correcting the gain error with weights estimated after 20 clock cycles. A clear reduction in the parasitic lines RP to the level of the quantization noise is apparent, which means a SNR ratio of 102 dB.

A practical case is presented below which uses simultaneous processing, in the sense of the invention, of both gain and offset matching errors. In this context, the gain and offset values are added to each channel as follows:

O=[−0.202;0.717;0.765;0.1832]×10⁻⁴

g=[1.0113;1.0146;1.0029;0.9884]

The spectral density of the output signal (with the useful signal SU), with consideration of the gain errors (RPG lines) and offset errors (RPO lines), is represented in FIG. 27. The value of these errors causes a total drop of 75 dB in the SNR ratio.

The first phase of correction is to compensate for the offset in each channel. This preferably occurs by connecting the input of the different modulators to the ground in order to be able to estimate the offset for each of these modulators. After the offset compensation, the second phase consists of applying a constant voltage to the input of the modulators in order to estimate the weight value for each channel, to allow equalizing the gains for all channels relative to the reference channel. In this phase, the estimation of the weight vector using the LMS algorithm takes into account the residual offset after the correction in each channel, as represented in FIG. 28. The maximum error of the estimated values is 2×10⁻⁷.

FIG. 29 shows the spectral density after offset correction and equalization of the gain errors. A considerable decrease in the parasitic lines is observed, which allows obtaining the expected SNR ratio.

In a practical implementation of this correction method, it may be advantageous to determine the size of the buffers in which the weight values w are stored, as well as the size of the buffers for the different calculation steps in the architecture of the LMS algorithm. In order to determine the optimum size of the buffers that will optimize the computation resources and the speed of the gain correction process, the number of bits necessary to quantify the weight values without impacting performance is first determined. To do this, the SNR ratio that is output is calculated as a function of the number of quantization bits Nbw for the weight values w, according to the following relation:

$${w}_{q} = \frac{\vert w \times {2}^{Nbw} \vert}{{2}^{Nbw}}$$

where w_{q} is the quantized value and ┌ ┐ is the rounding operator.

FIG. 30 shows the SNR ratio that is output as a function of the number of quantization bits for the weight values. Quantizing the weight values w in 16 bits seems sufficient to maintain the desired SNR ratio. In order to take into account the finite size of the registers in the weight value calculation algorithm, the quantized version of the LMS algorithm is applied, given by:

ŵ_{qi}[n+1]= [symbol] ŵ_{qi}[n]+μ( [symbol] y₁[n] [symbol] _{Nbr}− [symbol] yᵢ[n] [symbol] _{Nbr})× [symbol] yᵢ[n] [symbol] _{Nbr} [symbol] _{Nbw}

The operator [symbol] [symbol] represents the quantization of the value between brackets in Nb bits. It is given by:

$${A}_{q} = \frac{\vert A \times {2}^{Nb} \vert}{{2}^{Nb}}$$

Nbr indicates the length of the binary word at the output from the digital filter H(z) which is 25 bits in the example described. In order to determine the optimum number of bits Nbw, the weight values w are estimated by the SD-LMS algorithm while taking into account the effect of quantization. FIG. 31 shows the evolution in the estimation over time for different values of the number Nbw (16, 17, 19 and 20). Note that the quantization of the weight values w does not influence the rate of convergence. The influence of the number Nbw on the precision of the estimated values is illustrated in FIG. 32, which shows the difference between the estimated value and the theoretical value of the weight to be estimated as a function of the computation time n and for different values of the number Nbw (16, 17, 18 and 20). The more the number Nbw is increased, the more the estimation error is decreased. Quantizing the weight values in 20 bits thus appears sufficient to ensure a precision on the order of 6×10⁻⁷ and to maintain the desired performance. One can see that in practice, the optimum number Nbw is related to the resolution of the converter (denoted n and equal to 16 here). It turns out that it is generally advantageous for the number of bits Nbw to be between n and n+4, and preferably between n+1 and n+4.

To illustrate the effect of the number Nbw, FIG. 33 shows the spectral density of the output signal with gains equalized using weight values w estimated with different numbers Nbw. The more the number Nbw is increased, the more the amplitude of the parasitic lines RPG is decreased which improves the SNR ratio. A value of 20 for the number Nbw is sufficient to maintain the desired SNR ratio.

The results of the weight value estimation using other types of algorithms in the Least Mean Squares (LMS) family are summarized in Table I below. The table specifically shows the physical resources and the rate of convergence for these different types of processing.

TABLE 1
Summary of the physical resources required for the different types of
Least Mean Squares (LMS) algorithms.

| Algorithm | μ | Multiplications | Additions | Convergence time | Nbw |
|---|---|---|---|---|---|
| LMS | 1 | 1 | 2 | $Tc = 35 \frac{N}{{f}_{op}}$ | 18 |
| SD-LMS | 1 | 0 | 2 | $Tc = 20 \frac{N}{{f}_{op}}$ | 17 |
| SE-LMS | $\frac{1}{{2}^{16}}$ | 1 (shift) | 2 | $Tc = 780 \frac{N}{{f}_{op}}$ | 17 |
| SS-LMS | $\frac{1}{{2}^{16}}$ | 0 | 2 | $Tc = 1550 \frac{N}{{f}_{op}}$ | 17 |

Although the SE-LMS and SS-LMS algorithms are easier to implement than the LMS and SD-LMS algorithms, they have a higher convergence time. It appears that the algorithm providing a good compromise between physical complexity and convergence time is the SD-LMS algorithm. This type of algorithm, with the step-size μ=1, does not require a multiplier and only one accumulator for performing the additions is added to each channel, compared to the conventional structure of a multi-channel time-interleaved converter architecture.

We will now refer to FIG. 34 while summarizing a general processing in the sense of the invention.

The processing begins with compensating for offset COF, which preferably comprises the following steps:
applying a null signal as input to the converter to obtain only the offset as output in step S1,
using digital filtering H(z) to estimate an offset value for each channel in step S2, and
compensating for the estimated value of the offset on each channel, by making use of a means of compensation MC in step S3.

The processing continues with equalizing the gains EG, in which:
a same constant signal Vin is applied to each channel (step S4),
an output signal corresponding to a product of this same signal and a gain gᵢ specific to each channel is obtained in step S5, and
the product from each channel is compared to the product from a reference channel (step S6) in order to determine, for each channel, the estimation of a gain equalization weight wᵢ relative to the reference channel (step S7).

Estimating the weight for a channel is preferably conducted by iterative processing, using least mean squares LMS (step S8) and preferably SD-LMS which then only requires the addition of a simple accumulator (reference LMS in FIG. 20) in each channel of the time-interleaved architecture. The iterative processing is executed until the weight difference between two consecutive iterations becomes less than the desired precision (OK arrow exiting test T9). Then the equalization of the gains gᵢ as a function of the estimated weights wᵢ is performed (step S10).

FIG. 34 can illustrate an example of a general flow chart for the computer program of the invention.

The conditions for stopping the SD-LMS iterative processing (in test T9) are specified below. In theory, it should stop when the difference between the estimated value of the weight ŵᵢ[n+1] and its theoretical value wᵢ^{th} becomes less than the required precision. In this case, convergence is achieved. However, the theoretical value wᵢ^{th} is unknown. Stopping the iterative processing when the difference between successive weight estimates (ŵᵢ[n+1]−ŵᵢ[n]) is less than the desired precision is proposed here. This difference is calculated by filtering the estimated values with the SD-LMS algorithm (denoted ŵᵢ[n+1]) by a filter transfer function of the type (1−z⁻¹). In practice, the first two outputs from this filter are not taken into account, as they represent the transient response of the filter. FIG. 35 shows the numbers of iterations Nth and Ndiff respectively obtained with a theoretical calculation and with the calculation of the difference, in this embodiment, based on a 300-iteration Monte Carlo simulation of gain values in the different channels with a standard deviation σ_{g}=1%. One will note that the calculation using the difference ŵᵢ[n+1]−ŵᵢ[n]) presents a convergence time that is identical to the one obtained by the theoretical calculation.

It is also indicated that, in certain cases, the evolution of the estimated weight value may not be monotonic and may pass through areas of stability which could stop the execution of the LMS iteration before convergence is reached. To avoid such a situation, high order filter transfer functions of the type (1−Z^{Lf}) may be used. FIG. 36 shows the convergence time with a third order filter (Lf=3). One will note here that using such a filter, convergence is assured after at most Lf clock cycles in comparison to the convergence obtained by the theoretical calculation.

Of course, the invention is not limited to the embodiment described above as an example; it applies to other variants.

For example, the correction method proposed above may be applied to other types of parallel converter architectures using filter banks, in particular as described in document FR-08 54846.

More generally, the use of a comb filter for estimating the offset and the gain differences was described above. In the exemplary embodiment described above, a selective low-pass filter would be sufficient.

Also described above was a time-interleaved architecture using sigma-delta modulators. However, the invention does of course apply to time-interleaved architectures using other types of modulators.

1. Method for processing a signal, in an analog-to-digital converter comprising a multi-channel time-interleaved architecture, the method comprising:
digital filtering in each channel for at least estimating an offset error of the converter,
and a compensation for the offset as a function of the estimated offset error.

2. Method according to claim 1, wherein, said converter comprising at least one sigma-delta modulator in each channel, the digital filtering is applied in each channel in order to both:
reconstruct a useful signal issuing from the analog-to-digital conversion, and
estimate the offset error.

3. Method according to claim 1, wherein the offset compensation comprises the steps of:
applying a null signal as input to the converter in order to obtain the offset alone as output,
using the digital filtering to estimate an offset value for each channel, and
compensating for the estimated value of the offset on each channel.

4. Method according to claim 1, wherein the estimation of the offset error is performed by selective digital low-pass filtering.

5. Method according to claim 4, wherein the filtering is applied by a comb filter each channel.

6. Method according to claim 4, wherein the offset error is estimated at a precision of less than 10^{-(0.3n+1.9)}, where n is the resolution, in number of bits, of the converter.

7. Method according to claim 6, wherein a compensation of an offset error estimated at said precision limits the loss in the signal-to-noise ratio to less than 3 dB.

8. Method according to claim 1, wherein the digital filtering is additionally applied to equalize the gain across the different channels of the multi-channel architecture, after compensation for the offset.

9. Method according to claim 8, wherein:
a same constant signal is applied to each channel,
an output signal is collected, corresponding to a product of said same signal and a gain specific to each channel,
the product from each channel is compared to the product from a reference channel in order to estimate, for each channel, a gain equalization weight relative to the reference channel.

10. Method according to claim 9, wherein the weight estimation for a channel is conducted by applying iterative processing that uses least mean squares.

11. Method according to claim 10, wherein the processing follows a relation of the type
ŵᵢ[n+1]=ŵᵢ[n]+μfᵢ[n], where:
ŵᵢ[n+1] and ŵᵢ[n] are estimates of the weight for a channel i, respectively for the iterations n+1 and n,
μ is a constant,
fᵢ[n] is the product:
of the difference between the output signals from the reference channel and channel i, and the sign of the output signal from the channel i,
or of the output signal from channel i and the sign of the difference between the output signals from the reference channel and channel i,
or of the output signal from channel i and the difference between the output signals from the reference channel and channel i,
or of the sign of the output signal from channel i and the sign of the difference between the output signals from the reference channel and channel i.

12. Method according to claim 11, wherein the processing follows a relation of the type:
ŵᵢ[n+1]=ŵᵢ[n]+μ(y_{ref}[n]−yᵢ[n])×sgn(yᵢ[n]), where:
y_{ref} [n] and yᵢ[n] are the respective output signals from the reference channel and channel i, and
the notation sgn(x) indicates the sign of the real number x.

13. Method according to claim 8, wherein the equalization weight is estimated at a precision of less than 10^{-(0.34n-0.65)}, where n is the resolution, in number of bits, of the converter.

14. Method according to claim 11, wherein the equalization weight is estimated at a precision of less than 10^{-(0.34n-0.65)}, where n is the resolution, in number of bits, of the converter, and wherein the constant μ is chosen to optimize a rate of convergence of the iterative processing and achieve said precision.

15. Method according to claim 11, wherein the total number of iterations in the processing is chosen as a function of the constant μ.

16. Method according to claim 15, wherein a gain equalization based on an estimation of the weights to said precision limits the signal-to-noise ratio loss to less than 3 dB.

17. Method according to claim 9, wherein the weight values to be estimated are encoded in a number of bits of between n+1 and n+4, where n is the resolution, in number of bits, of the converter.

18. Analog-to-digital converter comprising a multi-channel time-interleaved architecture, wherein said converter comprises:
a digital filter in each channel, for at least estimating an offset error of the converter, and
a means of compensating for the offset as a function of the estimated offset error.

19. Converter according to claim 18, wherein it additionally comprises a means for equalizing the gain of the different channels, and wherein the digital filter is also made use of for estimating a gain equalization across the different channels of the multi-channel architecture, after compensation for the offset.

20. A non-transitory computer readable medium storing instructions for implementing the method according to claim 1 when this program is executed by a processor.
